(19) United States
(12) Patent Application Publication
(10) Pub. No.: US 2007/0146558 A1
(43) Pub. Date: Jun. 28, 2007

(54) Panel type television and liquid crystal television

(75) Inventor: Takayoshi Urisu, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 11/603,608

(22) Filed: Nov. 21, 2006

(30) Foreign Application Priority Data
Dec. 26, 2005 (JP) JP2005-372257

(51) Int. Cl. H04N 5/64

(52) U.S. Cl. 348/794

(57) ABSTRACT

The panel-type television includes a display panel which may be heated to a considerably high temperature when it is in use, a main substrate 20 arranged in the vicinity of the display panel, an electronic device 20a mounted on the main substrate 20, an exothermic device 20b mounted on the main substrate 20 so as to be arranged on a portion of the main substrate 20 which is lower than the electronic device 20a, and a bulkhead member 23 arranged between the display panel and the main substrate 20 so as to shield right, left and lower portions of the electronic device 20a and so as to be substantially perpendicular to the main substrate 20, so that the bulkhead member 23 is arranged between the electronic device 20a and the exothermic device 20b and the electronic device 20a is not subjected to heat of the exothermic device 20b.

### CROSS-REFERENCES TO RELATED APPLICATIONS

The present application is related to the Japanese Patent Application No. 2005-372257, filed Dec. 26, 2005, the entire disclosure of which is expressly incorporated by reference herein.

### BACKGROUND OF THE INVENTION

(1) Field of the Invention

The present invention relates to a panel-type television and a liquid crystal television, in which a substrate is mounted to a back face of a display panel.

(2) Description of Related Art

In a panel-type television such as a liquid crystal television, a substrate is required to be mounted to a back face of a display panel module and is always arranged vertically so as to be parallel to the module. Therefore, when the panel-type television is in use, heat blast is produced due to heat generated by the module and electronic components mounted on the substrate, and then goes up. As a result, any electronic component(s) which is arranged on an upper portion of the substrate is subjected to the heat blast. In particular, an electronic device(s) which is arranged between the module and the substrate is influenced by the heat blast.

Japanese Patent Application Laid-Open No. 2003-075858 discloses a heat-radiating construction for a wall-embedding type liquid crystal panel unit, in which a front cover of the liquid crystal panel unit has a forward projecting portion formed by causing a front surface of the front cover to be projected forward further than a mounting surface of the front cover and a plurality of air-vents are formed in a peripheral wall of the projecting portion. In the conventional heat-radiating construction, heat generated by electronic components mounted on a printed circuit board which is housed within a panel unit body is dissipated through the air-vents.

However, the conventional heat-radiating construction disclosed in the above patent document is not directed to a case where, when an exothermic device, and an electronic device in which a rise in temperature is required to be prevented are mounted on the same substrate, the electronic device is adapted not to be influenced by the heat generated from the exothermic device.

### BRIEF SUMMARY OF THE INVENTION

The present invention discloses a panel-type television such as a liquid crystal television, in which a substrate is arranged in the vicinity of a panel of the panel-type television which may be heated to a considerably high temperature when the panel-type television is in use, and an exothermic device and an electronic device in which a rise in temperature is required to be prevented are mounted on the same substrate so as to be vertically arranged, and which can prevent the electronic device from being influenced by heat generated in the exothermic device when the panel-type television is in use.

One aspect of the present invention provides a panel-type television comprising a flat display panel having a flat display surface provided at a front side thereof for displaying images on a screen of the flat display surface, and a plurality of bosses provided on a back face thereof, a speaker for outputting voice, a main substrate having various devices mounted thereon for receiving television broadcasts, causing the images to be displayed on the screen, and causing the speaker to output the voice, the main substrate being screw-fastened to the plurality of bosses of the flat display panel with a device-mounted surface thereof facing the back face of the flat display panel, the various devices including an electronic device and an exothermic device, the electronic device being mounted on a predetermined portion of the main substrate, the exothermic device being mounted on a portion of the main substrate which is lower than the predetermined portion of the main substrate on which the electronic device is mounted, a resin cabinet for housing the flat display panel, the speaker, and the main substrate, and a bulkhead member arranged between the flat display panel and the main substrate so as to be substantially perpendicular to the main substrate and so as to shield lower, left, and right portions of the electronic device.

More particularly, the electronic device is mounted on the predetermined portion of the main substrate, the exothermic device is mounted on the portion of the main substrate which is lower than the predetermined portion of the main substrate on which the electronic device is mounted, and the bulkhead member is arranged between the flat display panel and the main substrate so as to shield the lower, right and left portions of the electronic device and so as to be substantially perpendicular to the main substrate. Thus, the bulkhead member is arranged between the electronic device and the exothermic device, so that the electronic device can be prevented from being subjected to a rising stream of exothermic air which is generated due to heat produced by the exothermic device when the panel-type television is in use.

In the panel-type television of the present invention which is constructed as discussed above, a structure which allows the rising stream of exothermic air produced due to the heat generated by the exothermic device to escape is provided between the flat display panel and the main substrate, so that the electronic device is not subjected directly to heat blast going up from below and thermal rise of the electronic device can be suppressed. Moreover, this construction makes it possible to freely design a layout of devices on the main substrate without taking the arranging positions of the devices into consideration. In addition, it is possible to cause a distance between the flat display panel and the main substrate to be reduced, thus enabling to make the panel-type television further thinner. Moreover, in the panel-type television according to the present invention, any special members are not employed, so that except for the cost for bonding the members of the panel-type television, cost is not required. Therefore, it is possible to take a measure to prevent the thermal rise of the electronic device at low cost.

An optional aspect of the present invention provides a panel-type television, wherein the plurality of bosses comprise corner bosses provided at portions of the back face of the flat display panel which positionally correspond to corners of the main substrate, and a middle boss provided at a portion of the back face of the flat display panel which is adjacent the bulkhead member.

In this case, the main substrate is screw-fastened to the middle boss at a portion thereof which is adjacent the bulkhead member, so that adhesion of the main substrate to the bulkhead member is enhanced and, when the panel-type television is in use, influence of heat generated by the exothermic device on the electronic device can be reduced.

Another optional aspect of the present invention provides a panel-type television, wherein the middle boss is adapted to position the main substrate with respect to the flat display panel when the main substrate is to be mounted to the flat display panel.

In this case, the middle boss serves as means to position the main substrate with respect to the flat display panel when the main substrate is to be mounted to the flat display panel, so that the middle boss is advantageous.

Another optional aspect of the present invention provides a panel-type television, wherein the bulkhead member may have a cushioning material provided on a surface thereof which comes in contact with the main substrate when the main substrate is mounted to the flat display panel.

As the cushioning material, there may be employed a cushioning material made of cloth or the like. However, the cushioning material may be made of any other suitable material, as far as the material can exhibit a cushioning action.

In this case, adhesion between the bulkhead member and the main substrate is further enhanced and influence of the heat generated by the exothermic device on the electronic device can be reduced.

Another aspect of the present invention provides a liquid crystal television comprising a liquid crystal module having a flat display surface provided at a front side thereof for displaying images on a screen of the flat display surface, and a plurality of bosses provided on a back face thereof, a speaker for outputting voice, a main substrate having various devices mounted thereon for receiving television broadcasts, causing the images to be displayed on the screen, and causing the speaker to output the voice, the main substrate being screw-fastened to the plurality of bosses of the liquid crystal module with a device-mounted surface thereof facing the back face of the liquid crystal module, the various devices including an electronic device and an exothermic device, the electronic device being mounted on a predetermined portion of the main substrate, the exothermic device being mounted on a portion of the main substrate which is lower than the predetermined portion of the main substrate on which the electronic device is mounted, a resin cabinet for housing the liquid crystal module, the speaker, and the main substrate, a bulkhead member having a thickness corresponding to a distance between the main substrate and the liquid crystal module, and interposedly held between the main substrate and the liquid crystal module, the bulkhead member being formed into a substantially U-shape which allows the bulkhead member to surround the electronic device, the bulkhead member being interposedly held between the main substrate and the liquid crystal module so as to surround the electronic device, with an opening thereof facing upward, the plurality of bosses comprising corner bosses provided at portions of the back face of the liquid crystal module which positionally correspond to corners of the main substrate, and a middle boss provided on a portion of the back face of the liquid crystal module which is adjacent the bulkhead member, the middle boss serving as means to position the main substrate with respect to the liquid crystal module when the main substrate is to be mounted to the liquid crystal module, and a cushioning material provided on a surface of the bulkhead member which comes in contact with the main substrate.

Of course, it goes without saying that the liquid crystal television can exert the same functions as the panel-type television can do.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a schematic perspective view of a liquid crystal television according to an embodiment of the present invention, as viewed from an oblique front side;

FIG. 2 is an exemplary illustration of a schematic perspective view of the liquid crystal television as viewed from an oblique rear side;

FIG. 3 is an exemplary illustration of a schematic perspective view of the liquid crystal television as viewed from the oblique rear side, in which a back cabinet member is removed;

FIG. 4 is an exemplary illustration of a block diagram exhibiting a structure of the liquid crystal television according to the embodiment of the present invention;

FIG. 5 is an exemplary illustration of a schematic exploded perspective view of the liquid crystal television, which is of assistance in explaining a mounting construction for a bulkhead member;

FIG. 6 is an exemplary illustration of a schematic vertically sectional view of the bulkhead member, an electronic device, and an exothermic device; and

FIG. 7 is an exemplary illustration of a schematic vertically sectional view of a modification of the bulkhead member shown in FIG. 5, the electronic device, and the exothermic device.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

An embodiment according to the present invention will be discussed in the following order:

(1) Structure of Panel-type Television;

(2) Structure of Bulkhead Means and Mounting Construction Therefor;

(3) Summary.

(1) Structure of Panel-Type Television:

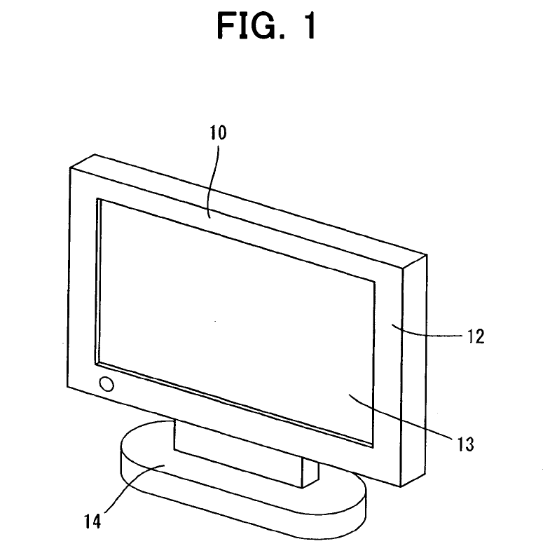

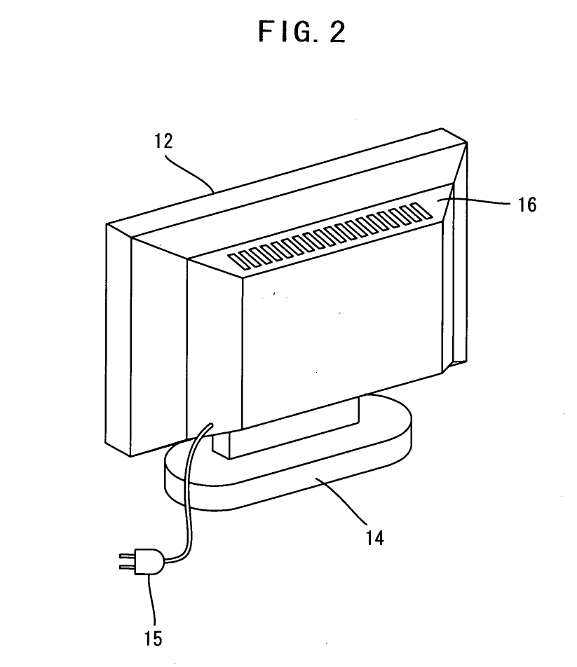

A liquid crystal television 10 according to the embodiment of the present invention will be discussed hereinafter. FIG. 1 is a schematic perspective view of the liquid crystal television 10 as viewed from an oblique front side. FIG. 2 is a schematic perspective view of the liquid crystal television as viewed from an oblique rear side. The liquid crystal television 10 comprises a cabinet, a liquid crystal module 13, and a leg portion 14. The cabinet comprises a resin front cabinet member 12 and a resin back cabinet member 16 which are combined with each other. The liquid crystal module 13 has a flat display surface provided at a front side thereof for displaying images on a screen thereof. The front cabinet member 12 has a substantially rectangular opening. The liquid crystal module 13 is held by the front cabinet member 12 with the display surface thereof being exposed through the opening of the front cabinet member 12.

Moreover, the front cabinet member 12 has a speaker (not shown) provided in an inside thereof for outputting voice. The back cabinet member 16 is provided at a central portion thereof with a thick section projecting rearward, in which a main substrate on which devices are mounted as will be discussed hereinafter is housed. Moreover, the thick section of the back cabinet member 16 is formed at an upper portion thereof with air-vents for allowing heat generated in use of the liquid crystal television 10 to be dissipated therethrough. The leg portion 14 supports a sheet of metal which is housed within the cabinet and mounted to the front cabinet member 12, whereby the display surface of the liquid crystal module 13 is maintained substantially vertical. While the liquid crystal module 13 is employed as a flat display panel in the illustrated embodiment, any suitable display panel may be employed as far as it is a panel-type display panel and, of course, a display panel for a plasma display device may be employed.

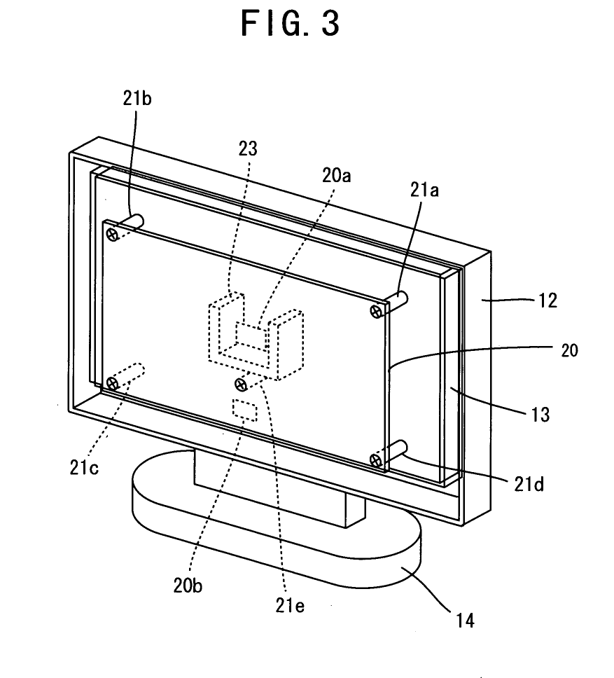

FIG. 3 is a schematic perspective view of the liquid crystal television 10 as viewed from the oblique rear side, in which the back cabinet member 16 is removed. The liquid crystal module 13 has screw-receiving bosses which are provided on a back face of the liquid crystal module 13 so as to be aligned with threaded holes formed in the main substrate 20 which is to be mounted to the liquid crystal module 13 for assembling. More particularly, in the illustrated example, the liquid crystal module 13 has corner bosses 21a-21d provided at four corners of the back face of the liquid crystal module 13, and a middle boss 21e provided at a substantially central portion of the back face of the liquid crystal module 13. These bosses 21a-21e are fastened to the main substrate 20 by causing screws to be fastened into the bosses 21a-21e and the threaded holes formed in portions of the main substrate 20 which positionally correspond to the bosses 21a-21e of the liquid crystal module 13 when the main substrate 20 is mounted to the liquid crystal module 13 for the assembling, whereby the main substrate 20 is supported to the back face of the liquid crystal module 13. Moreover, a bulkhead member 23 is provided between the liquid crystal module 13 and the main substrate 20.

Of course, a second substrate on which any component(s) having a function different from functions of the devices mounted on the main substrate 20 is mounted may be arranged at the back face of the liquid crystal module 13, and a second bulkhead member may be provided between the back face of the liquid crystal module 13 and the second substrate.

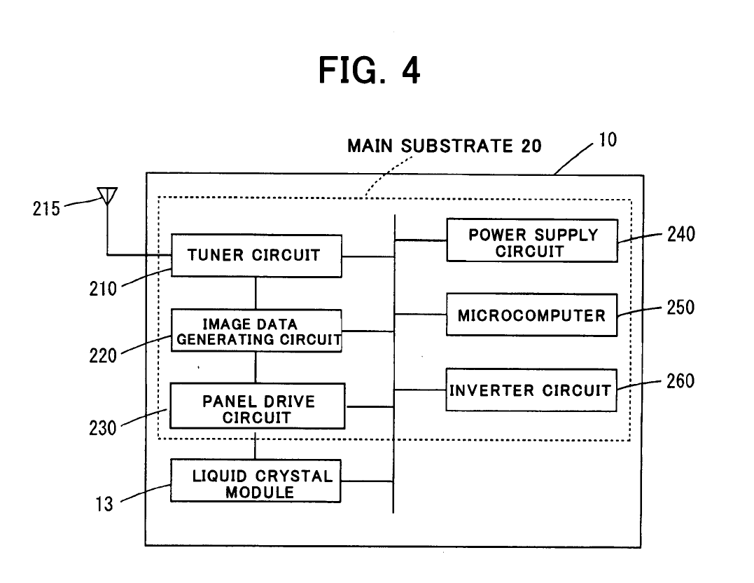

FIG. 4 is a block diagram exhibiting a structure of the liquid crystal television 10 according to the embodiment of the present invention. The liquid crystal television 10 generally includes a tuner circuit 210 connected to an antenna 215, an image data generating circuit 220, a panel drive circuit 230, the liquid crystal module 13, a power supply circuit 240, a microcomputer 250, and an inverter circuit 260.

In the liquid crystal television 10 constructed as discussed above, the microcomputer 250 is electrically connected to the respective circuits of liquid crystal television 10. The microcomputer 250 comprises a CPU, a ROM, and a RAM as elements making-up the microcomputer 250. The CPU is designed so as to control the entire liquid crystal television 10 according to respective programs written in the ROM and RAM. Incidentally, the CPU, the ROM, and the RAM are not shown in FIG. 4.

The tuner circuit 210 is designed such that it is controlled by the microcomputer 250, to thereby receive television broadcasts from the antenna 215, extracts image signals, serving as intermediate frequency signals, from television broadcast signals, while carrying out a predetermined signal amplification process or the like, and outputs the image signals to the image data generating circuit 220. The image data generating circuit 220 is designed such that it converts the inputted image signals into digital signals according to signal levels of the image signals, carries out a matrix conversion process on the basis of brightness signals and color-difference signals which are extracted from the image signals, and generates RGB (red, green, and blue) signals as image data.

The RGB signals are inputted to the panel drive circuit 230 in which the RGB signals are subjected to a scaling process so as to coincide with the number of pixels (aspect ratio: m:n) of the liquid crystal module 13, and image data for one screen to be displayed on the liquid crystal module 13 is generated. The generated image data is outputted to the liquid crystal module 13 on which images based on the image data are then displayed.

The liquid crystal module 13 has liquid crystal display panels, a back light, and a control circuit. The control circuit of the liquid crystal module 13 is an electronic circuitry which is adapted to carry out a control-drive processing of a screen display and produce, from the image data outputted from the panel drive circuit, voltages which drive a liquid crystal panel for R (red), a liquid crystal panel for G (green) and a liquid crystal panel for B (blue) each color. The back light is adapted to receive a high voltage from the inverter circuit 260 and then light up. Light emitted from the back light passes through the respective liquid crystal panels from the back side to the front side. Thus, the liquid crystal module 13 displays images corresponding to the image data, i.e., images corresponding to the image signals, through the screen thereof.

The power supply circuit 240 is adapted to receive a supply voltage (alternating voltage) from an external commercial power source or the like, and supply the received supply voltage to the respective circuits including the inverter circuit 260 and the like, as well as the microcomputer 250. The power supply circuit 240 is adapted to convert the voltage to be supplied to the respective circuits, from an alternating voltage to a direct current voltage, as required.

The inverter circuit 260 is adapted to convert the direct current voltage supplied from the power supply circuit 240 to an alternating voltage, supply the alternating voltage to the back light as a drive signal and cause the back light to light up.

The tuner circuit 210, the image data generating circuit 220, the panel drive circuit 230, the power supply circuit 240, the microcomputer 250, and the inverter circuit 260 are mounted on the main substrate 20. The circuits perform signal-processes with respect to the television broadcasts received through the antenna 215, allow images to be displayed on the liquid crystal module 13, and output voice to the speaker.

(2) Structure of Bulkhead Means and Mounting Construction Therefor:

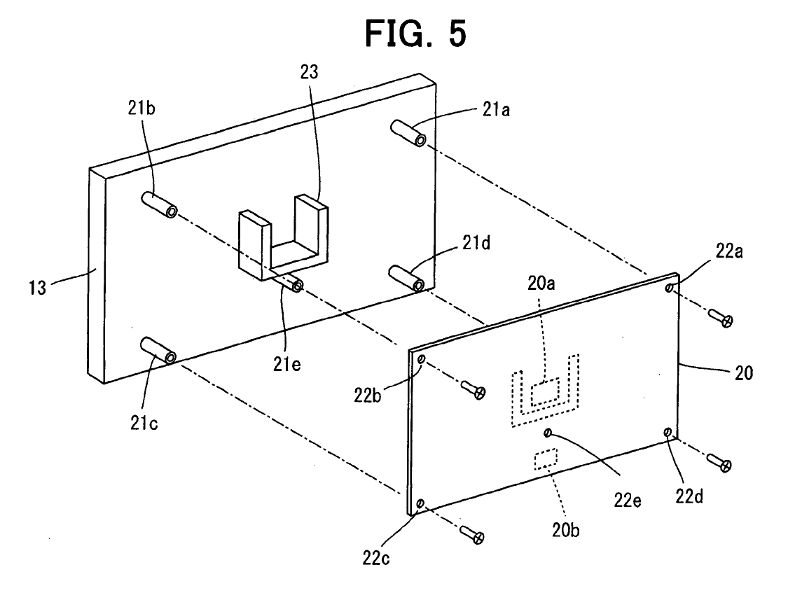

FIG. 5 is a schematic exploded perspective view showing a mounting construction for the bulkhead member 23 that is to be arranged between the liquid crystal module 13 and the main substrate 20. The corner bosses 21a-21d are provided on the back face of the liquid crystal module 13 so as to vertically stand up from the four corner portions of the back face of the liquid crystal module 13 which positionally correspond to the threaded holes 22a-22d formed in the main substrate 20. Moreover, the bulkhead member 23 of a substantially U-shape is arranged on a substantially central portion of the back face of the liquid crystal module 13 with an opening thereof facing upward. The bulkhead member 23 is formed into a substantially U-shape which allows an electronic device 20a mounted on the main substrate 20 to be surrounded by the bulkhead member 23, when the main substrate 20 is mounted to the liquid crystal module 13 for the assembling. More particularly, the bulkhead member 23 is arranged on the liquid crystal module with the opening thereof facing upward, so as to surround the electronic device 20a when the main substrate 20 is mounted to the liquid crystal module 13 for the assembling.

The bulkhead member 23 is formed of resin and has a thickness substantially corresponding to a space between the liquid crystal module 13 and the main substrate 20 which are combined with each other. The bulkhead member 23 is interposedly held between the liquid crystal module 13 and the main substrate 20. While the bulkhead member 23 is formed independently of the liquid crystal module 13 and bonded onto the back face of the liquid crystal module 13 in the illustrated embodiment, of course, the bulkhead member 23 and the liquid crystal module 13 may be formed as a one-piece component. The middle boss 21e is provided on the back face of the liquid crystal module 13 so as to vertically stand up from a portion of the back face of the liquid crystal module 13 which is lower than the bulkhead member 23 and adjacent the bulkhead member 23. While the arranging position of the middle boss 21e is below the bulkhead member 23 as shown in FIG. 5, the middle boss 21e may be provided on the liquid crystal module 13 so as to be arranged on the left or right of the bulkhead member 23, or so as to be arranged at a portion of the liquid crystal module 13 which is upper than the portion of the liquid crystal module 13 at which the bulkhead member 23 is arranged.

On the other hand, the main substrate 20 has the threaded holes 22a-22d formed in portions thereof which positionally correspond to the corner bosses 21a-21d of the liquid crystal module 13 when the main substrate 20 is mounted to the liquid crystal module 13. Also, the main substrate 20 has a threaded hole 22e formed in a portion thereof which positionally corresponds to the middle boss 21e of the liquid crystal module 13 when the main substrate 20 is mounted to the liquid crystal module 13. Screws are fastened into the threaded holes and the corner and middle bosses, whereby the main substrate 20 is supported to the back face of the liquid crystal module 13. The electronic device 20a is mounted on a substantially central portion of the main substrate 20. Moreover, an exothermic device 20b is mounted on a portion of the main substrate 20 which is substantially lower than the portion of the main substrate 20 on which the electronic device 20a is mounted.

The electronic device 20a is a device, thermal rise of which, in use of the liquid crystal television 10, is objectable. The electronic device 20a may comprise, for example, an integrated circuit (IC), a chip set or the like. The exothermic device 20b is a device that is easy to produce heat when the liquid crystal television 10 is in use, and may comprise, for example, a regulator for the power supply circuit, a field-effect transistor, a transformer or the like.

In a condition where the main substrate 20 is mounted to the liquid crystal module 13, the electronic device 20a is sandwiched between the liquid crystal module 13 and the main substrate 20, and surrounded at lower, left and right side portions thereof by the bulkhead member 23. Therefore, a path of air is provided at only an area upper than the electronic device 20a. When the liquid crystal television 10 is in use, the electronic device 20a is not directly subjected to a rising stream of exothermic air which is generated due to heat produced in the exothermic device 20b which is arranged below the electronic device 20a.

While the electronic device 20a is arranged on the substantially central portion of the main substrate 20 as shown in FIG. 5, of course, the electronic device 20a may be arranged anywhere in the main substrate 20. In connection with this, the bulkhead member 23 is arranged on a portion of the liquid crystal module 13 which allows the bulkhead member 23 to surround the lower, left and right side portions of the electronic device 20a at the place of the main substrate 20 where the electronic device 20a is arranged. Correspondingly, arranging positions of the exothermic device 20b, the middle boss 21e, and the threaded hole 22e are changed.

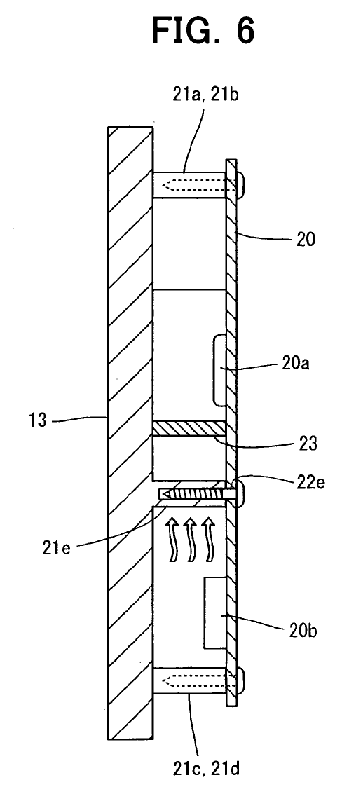

FIG. 6 is a schematic vertically sectional view of the bulkhead member 23, the electronic device 20a and the exothermic device 20b. In the illustrated example, the liquid crystal module 13 and the main substrate 20 are spaced apart from each other at a predetermined distance and kept parallel to each other by the corner bosses 21a-21d which are vertically arranged at the left and right portions of the liquid crystal module 13. The electronic device 20a and the exothermic device 20b are mounted on a surface of the main substrate 20 which faces the back face of the liquid crystal module 13. The main substrate 20 may be a substrate of a type, on only one surface of which electronic devices are to be mounted, or a substrate of a type, on both surfaces of which electronic devices are to be mounted, as far as the electronic device 20a and the exothermic device 20b are mounted on a surface of the substrate which faces the back face of the liquid crystal module 13.

The middle boss 21e stands up from the portion of the back face of the liquid crystal module 13 which is adjacent and lower than the portion of the back face of the liquid crystal module 13 on which the bulkhead member 23 is mounted, and projects toward the main substrate 20. The middle boss 21e is screw-fastened to the main substrate 20 through the threaded hole 22e of the main substrate 20. That is, the main substrate 20 is further fastened to the liquid crystal module 13 by causing a screw to be fastened into the threaded hole 22e of the main substrate 20 and the middle boss 21e of the liquid crystal module 13, whereby adhesion of the main substrate 20 to the bulkhead member 23 can be enhanced and the electronic device 20a can be positively protected from heat blast which is generated due to heat produced by the exothermic device 20b which is arranged below the electronic device 20a. Incidentally, the mounting of the main substrate 20 to the liquid crystal module 13 may be carried out by firstly causing the main substrate 20 to be screw-fastened to the middle boss 21e of the liquid crystal module 13 through the threaded hole 22e of the main substrate 20, and secondly causing the main substrate 20 to be screw-fastened to the corner bosses 21a-21d of the liquid crystal module 13 through the threaded holes 22a-22b of the main substrate 20. Thus, the middle boss 21e of the liquid crystal module 13 also serves as means to position the main substrate 20 with respect to the liquid crystal module 13 when the main substrate 20 is to be mounted to the liquid crystal module 13.

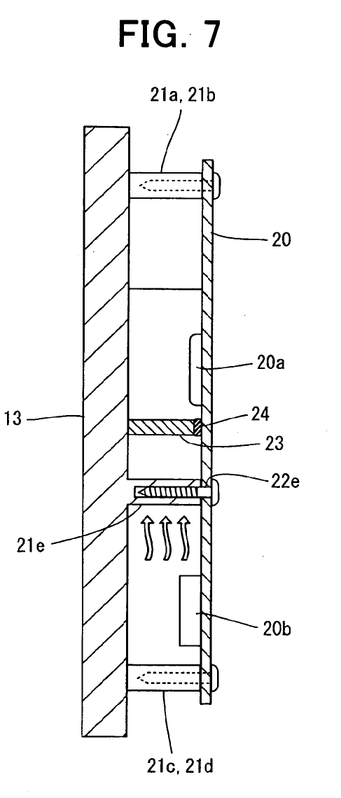

FIG. 7 is a schematic vertically sectional view which is of assistance in explaining a modification of the bulkhead member shown in FIG. 6 and, more particularly, a schematic vertically sectional view of the modification, the electronic device 20a and the exothermic device 20b. In this illustrated example, the bulkhead member 23 has a cushioning member 24 bonded onto a surface thereof which comes in contact with the main substrate 20. Thus, the adhesion of the bulkhead member 23 to the main substrate 20 is further enhanced in such a manner not to allow a space to be produced between the bulkhead member 23 and the main substrate 20. Incidentally, the cushioning member 24 is formed into a substantially U-shape corresponding to that of the bulkhead member 23. The cushioning member 24 is bonded onto the surface of the bulkhead member 23 in the same posture as the bulkhead member 23.

More particularly, the total length of the bulkhead member 23 and the cushioning member 24 (measured in a lateral direction of a sheet of FIG. 7) is designed so as to be slightly longer than heights of the corner bosses 21a-21d defining the distance between the liquid crystal module 13 and the main substrate 20. As discussed above, the main substrate 20 is screw-fastened to the liquid crystal module 13 through the middle boss 21e and the threaded hole 22e, so that the adhesion of the bulkhead member 23 to the main substrate 20 can be further enhanced. As the cushioning member 24, there may be employed, for example, a piece of cloth. However, in addition to cloth, the cushioning member 24 may be made of any suitable material, as far as the material can exhibit a cushioning action.

(3) Summary:

As discussed above, according to the embodiment of the present invention, the electronic device 20a is mounted on the main substrate 20, the exothermic device 20b is also mounted on the main substrate 20 so as to be arranged below the electronic device 20a, and the bulkhead member 23 is arranged so as to shield the lower, left and right side portions of the electronic device 20a and so as to be substantially perpendicular to the main substrate 20, when the main substrate 20 is mounted to the liquid crystal module 13 for the assembling. Thus, in the assembled liquid crystal television 10, the bulkhead member 23 is located between the electronic device 20a and the exothermic device 20b. Therefore, the electronic device 20a is not subjected to the rising stream of exothermic air which is generated due to the heat produced by the exothermic device 20b when the liquid crystal television 10 is in use.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A liquid crystal television comprising:
a liquid crystal module having a flat display surface provided at a front side of the liquid crystal module for displaying images on a screen of the flat display surface, and a plurality of bosses provided on a back face of the liquid crystal module;
a speaker for outputting audio;
a main substrate having various devices mounted thereon for receiving television broadcasts, display of images on the screen, and output of audio from the speaker;
the main substrate coupled with the plurality of bosses of the liquid crystal module with a device-mounted surface of the substrate facing the back face of the liquid crystal module;
the various devices including an electronic device and an exothermic device;
the electronic device coupled with a predetermined portion of the main substrate;
the exothermic device coupled with a portion of the main substrate which is lower than the predetermined portion of the main substrate on which the electronic device is coupled;
a resin cabinet for housing the liquid crystal module, the speaker, and the main substrate;
a bulkhead member having a thickness corresponding to a distance between the main substrate and the liquid crystal module, and interposedly held between the main substrate and the liquid crystal module;
the bulkhead member is substantially U-shape which allows the bulkhead member to surround the electronic device;
the bulkhead member being interposedly held between the main substrate and the liquid crystal module so as to surround the electronic device, with an opening of the bulkhead member facing upward;
the plurality of bosses comprising corner bosses provided at portions of the back face of the liquid crystal module which positionally correspond to corners of the main substrate, and a middle boss provided on a portion of the back face of the liquid crystal module which is adjacent the bulkhead member;
the middle boss serving as means to position the main substrate with respect to the liquid crystal module, when the main substrate is to be mounted to the liquid crystal module; and
a cushioning material provided on a surface of the bulkhead member which comes in contact with the main substrate.

2. A panel-type television comprising:
a flat display panel having a flat display surface provided at a front side of the flat display panel for displaying images on a screen of the flat display surface, and a plurality of bosses provided on a back face of the flat display panel;
a speaker for outputting audio;
a main substrate having various devices mounted thereon for receiving television broadcasts, display of images on the screen, and output of audio from the speaker;
the main substrate coupled with the plurality of bosses of the liquid crystal module with a device-mounted surface of the substrate facing the back face of the liquid crystal module;
the various devices including an electronic device and an exothermic device;
the electronic device coupled with a predetermined portion of the main substrate;
the exothermic device coupled with a portion of the main substrate which is lower than the predetermined portion of the main substrate on which the electronic device is coupled;
a resin cabinet for housing the flat display panel, the speaker, and the main substrate; and
a bulkhead member arranged between the flat display panel and the main substrate so as to be substantially perpendicular to the main substrate and so as to shield lower, left, and right portions of the electronic device.

3. A panel-type television according to claim 2, wherein the plurality of bosses comprise corner bosses provided at portions of the back face of the flat display panel which positionally correspond to corners of the main substrate, and a middle boss provided at a portion of the back face of the flat display panel which is adjacent the bulkhead member.

4. A panel-type television according to claim 3, wherein the middle boss is adapted to position the main substrate with respect to the flat display panel when the main substrate is to be mounted to the flat display panel.

5. A panel-type television according to claim 2, wherein the bulkhead member has a cushioning material provided on a surface thereof which comes in contact with the main substrate.

6. A panel-type television according to claim 2, wherein the bulkhead member is formed into a substantially U-shape and arranged between the flat display panel and the main substrate with an opening thereof facing upward.

7. A panel-type television according to claim 6, wherein the bulkhead member has a cushioning material provided on a surface thereof which comes in contact with the main substrate, the cushioning material being formed into a substantially U-shape corresponding to that of the bulkhead member, and bonded onto the surface of the bulkhead member in the same posture as the bulkhead member.
